(19) United States
(12) Patent Application Publication
(10) Pub. No.: US 2015/0269682 A1
(43) Pub. Date: Sep. 24, 2015

(54) ONLINE AUCTIONS WITH COLLECTIBLE AUTHENTICITY INSURANCE SYSTEMS AND METHODS

(71) Applicant: COLLECTORS COFFEE, INC., Las Vegas, NV (US)

(72) Inventor: Mykalai Kontilai, Las Vegas, NV (US)

(73) Assignee: COLLECTORS COFFEE, INC., Las Vegas, NV (US)

(21) Appl. No.: 14/286,730

(22) Filed: May 23, 2014

Related U.S. Application Data
(63) Continuation of application No. 14/120,326, filed on May 14, 2014.
(60) Provisional application No. 61/968,988, filed on Mar. 21, 2014.

(51) Int. Cl. G06Q 40/08; G06Q 30/06

(52) U.S. Cl. CPC G06Q 40/08; G06Q 30/0609

(57) ABSTRACT

Systems and methods for facilitating a dynamic online based community for collectors of collectible items which provides various features, including a feature by which collectibles of all kinds are authenticated and insured against subsequent claims or challenges to that authentication prior to permitting the collectible to be involved in a transaction.

### CROSS-REFERENCE TO RELATED APPLICATIONS

This application is a continuation of U.S. Non-provisional application Ser. No. 14/120,326, filed May 14, 2014, and claims the benefit of U.S. Provisional Application No. 61/968,988, filed Mar. 21, 2014, the disclosures of which are incorporated herein by reference.

### COPYRIGHT NOTICE

Subject matter disclosed herein contains material that is subject to copyright protection. The copyright owner has no objection to the facsimile reproduction by anyone of the patent documents as they appear in the U.S. Patent and Trademark Office, patent file or records, but reserves all copyrights whatsoever in the subject matter presented herein.

### TECHNICAL FIELD

The subject matter disclosed herein relates generally to an online platform which is configured to function as a hub, marketplace and center of activity, such as transactions and the sharing of information, relating to an area of interest, and more particularly, to systems and methods for supporting the online platform with features for facilitating social networking, authentication, broadcast, publication, verification, fraud prevention, insuring and registering collectibles, all in connection with the online sale, purchase, auction and management of collections of collectible merchandise.

### BACKGROUND OF THE INVENTION

Online auctions and classified sites have become popular if not preferable ways for purchasing certain goods. This is particularly true with regard to collectible items, known and also referred to herein as “collectibles,” at least because such collectibles are often privately owned by individuals or recognized dealers and not generally found in retail stores. Since there are many online classified and auction sites, the process of purchasing and selling collectibles often requires searching multiple sites and placing of multiple identical advertisements. Even when a sought after collectible is found and available for sale, the purchaser is most often forced to rely on either the seller's word that the collectible is authentic or a dubious certificate of authenticity.

Attempts have been made to create systems and methods that provide for authentication and verification to potential purchasers of items sold online.

US Patent Publication No. 20010047340 to Snow et al. is directed to an authenticity and verification method and apparatus for insuring authenticity for consumer goods as well as products transferred to another party, which includes providing a record of authenticity with a good at the point of manufacture. The record of authenticity includes an item code and a registration number unique to the good, which is stored in an internet database. Once an article or good is purchased, the owner of the article accesses the database and is forwarded a second registration number which is different from the initial registration number provided at the point of manufacture. The owner may register as a legitimate owner of authentic goods by entering the new registration number and item code as well as other information. This information is stored in the internet database for the good in issue. The system also provides for insuring that any good transferred in title to a second party is an authentic article and also lists information for this party relative to the article.

US Patent Publication No. 20010049606 to Lucarelli is directed to an online collectible authentication and ownership system which includes an individual web page hosted by an online company for that unique item, wherein the web page displays a digital image, written description and current owner of that unique item. The individual web page is assigned a unique URL address and password. This web page represents an electronic title of ownership viewable by any Internet connection worldwide in a format that excludes the owner's personal information. As the object is sold, traded or otherwise changes owners, this process is facilitated by the additional exchange of the Internet-based electronic title, as the current owner transfers the password to the new owner who subsequently changes the personal ownership information on the electronic title.

US Patent Publication No. 20050216360 to Osterer is directed to a system and method for keeping track of the ownership of unique items in a system including a server computer connected to a database and at least one client computer connected to the server computer over a network. In operation information concerning the item is entered into the client computer. This information, includes at least a description of the item and its owner, is uploaded from the client computer to said server computer where the information is stored in the database. In response, the system provides from the server to the client computer a transaction identification number related to the information and an item number related to the item. A user at the client computer can use the transaction identification number to access the uploaded information at the database to determine the current owner of the item. Upon a transfer of ownership, the new owner can use at least one client computer to enter the transaction identification number and new owner information to update the information in the database to indicate the new owner and to indicate the prior owner as a seller of the item. In response a new transaction identification number is provided from the server computer to the client computer.

US Patent Publication No. 20070079139 to Kim is directed to signature authentication systems and methods carried out by collecting signature data from a signer. A signer employs a bio-pen to electronically sign a file. Signature data corresponding to the bodily movements associated with producing the signer's signature are collected and authenticated against a standard. If the signature data is authenticated a signature certificate including the authenticated signature data is generated and assigned to an electronic envelope. Additional data, such as a bio-pen serial number, time stamps, and user identifier can be collected and used for authentication and inclusion in a signature certificate. Assigning the signature certificate secures the contents of the electronic envelope and signature certificate. The authenticity of the contents of an envelope and the associated signature certificate can be invalidated if unauthorized interaction occurs with the electronic envelope, contents, or signature certificate. Authorized viewers/signers are alerted if such unauthorized interaction occurs.

US Patent Publication No. 20080168270 to Kulakowski et al. is directed to an electronic secure authentication for exchange buying system that provides the ability to reserve, order, or purchase products or services directly from eCommerce providers, retailers, manufacturers, distributors, brokers, auctions and service providers in a safe and secure fashion by receiving authentication notifications and product certification throughout the ordering/purchase procurement process.

US Patent Publication No. 20100180207 to MacGuire is directed to a system and method which allows celebrities to manage and fulfill memorabilia requests remotely including a personalized audio or video greeting, with objectives of creating a network of celebrities who can fulfill certain memorabilia requests remotely, allowing users to make certain memorabilia requests to a celebrity in this network, wherein the celebrity can manage the memorabilia requests, create the requested memorabilia, review the results, and submit the memorabilia for delivery to the user making the request.

US Patent Publication No. 20100250424 to Torres is directed to a method and system to produce entertainment media by combining a social network service providing a way for member/producers and member/investors to form communities in order to produce and invest in entertainment media companies, with an alternative trading system enabling member/producers and member/investors using the social network service thru internet enabled digital devices to list, quote, buy, sell and trade in initial public offerings and/or secondary trading of equity shares of entertainment media companies, and electronic communications networks that match buy/sell orders of entertainment media companies selling equity stocks with investors purchasing said stocks.

US Patent Publication No. 20100250616 to Kim is directed to a memorabilia registry system in which information regarding an item, such as the signer, a list of all signers, or authentication of signature, is initially entered into the registry with a time stamp and additional information about the item may also be added over the life of the item. The information in the registry can provide authentication of an item's past and can be useful in establishing the chain of title.

US Patent Publication No. 20110066452 to Hall et al. is directed to systems and methods for insuring digital media download transactions that enable a user to selectively insure purchased digital media items downloaded over a network connection. In one example, a method is provided that includes the steps of receiving first user data from a user at the digital media system to request the purchase of a selected digital media item from a content provider, providing a message to the user to offer loss insurance for the selected digital media item, and receiving second user data at the digital media system to indicate whether the loss insurance offer is accepted. Acceptance data is transmitted to the content provider via the digital network to indicate whether the loss insurance offer is accepted.

US Patent Publication Nos. 20110208615 and 20110208655, each to Steelberg et al., are directed to a system and method for creating and marketing authentic virtual memorabilia including at least one computer server, at least one database connected to the at least one computer server, a communication connection for connecting the at least one computer server to a network, software hosted on the at least one computer server, the software configured to create a marketplace for limited edition authentic virtual memorabilia, provide an auction environment for said authentic virtual memorabilia, and allow display of the limited edition authentic virtual memorabilia in a showcase.

US Patent Publication No. 20120316998 to Castineiras is directed to computer based system for management of memorabilia including a processor coupled to memory and an input-output controller, a data store in communication with the processor, an input device coupled to the input-output controller and a display device coupled to the input-output controller. The memory includes at least one algorithm comprising an initial processing section configured to upload a plurality of images and audio files having a plurality of data file formats. The memory includes an organization and storage section configured to determine at least one location within the data store for storage of each of the plurality of images and audio files. The memory also includes an access and display section configured for at least one of creating, retrieving, viewing, moving, annotating and transmitting the images and audio files.

U.S. Pat. No. 7,389,247 to Pestoni et al. is directed to an article of manufacture including a computer user medium having computer readable code embodied thereon which provides a method of insuring purchased distributed digital content for a consumer of the purchased digital content. By purchasing insurance on content, at a later time consumers are able to return to the content distribution channels and re-obtain the previously purchased content in the same, or new format as the original purchased.

U.S. Pat. No. 8,341,033 to Porat et al. is directed to methodology, system and business model are disclosed for facilitating a fully automated buyer's auction in which the major types of transaction costs are significantly reduced by providing the buyer and the sellers with near-perfect information about one another, including information about buyer preferences and competing sellers' offers. The system implements a buyer's auction with multidimensional bidding that minimizes market intelligence, search, bargaining and transaction execution costs and thus creates more competitive, frictionless markets. Buyers and sellers can efficiently conduct the buyer's auction within a unified environment, thereby minimizing buyer integration costs as well. The buyer's auction generates commercially marketable proprietary information and a revenue stream for the auctioneer providing such a service.

All of the references cited herein are incorporated by reference in their entireties to assist in providing enabling background for systems, methods and technologies.

The aforementioned attempts to provide systems and methods for authenticating items fail to offer systems and methods for providing a central hub that facilitates the authentication of all collectibles by independent experts in the relevant field, the administration of an insurance policy backing the authenticated collectibles, and the registration of collectibles and insurance policies associated with the collectibles, among other things, all in connection with transactions involving the collectibles. The invention seeks to address these features, among others, which have failed to be sufficiently addressed in prior systems and methods.

### SUMMARY OF THE INVENTION

Some embodiments of the invention are directed to a process for providing an authenticity guarantee for a collectible offered to potential buyers through a global online marketplace by providing potential buyers with authentication by a collectible expert dealer and insuring the authenticity of the collectible through an insurance policy underwritten by an established insurance provider.

In some embodiments, the aforementioned process further includes the step of storing information relating to the collectible offered to potential buyers in a collectible registry.

In some embodiments, the information stored includes the identity of the owner of the collectible.

In some embodiments, the aforementioned process further includes the step of receiving information relating to the collectible from a user having a user profile in the online marketplace.

In some embodiments, the aforementioned process further includes the step of displaying recommendations relating to collectibles offered to the user based at least partially on user activity in the online marketplace.

In some embodiments, the aforementioned process further includes the step of facilitating the purchase of the collectible through an escrow process.

In some embodiments, the aforementioned process further includes the steps of: a) receiving dealer data relating to a plurality of collectible dealers, wherein the dealer data for each collectible dealer includes information qualifying the dealer as a collectible expert for one or more categories of collectibles selected from a plurality of preset categories of collectibles and an association between the dealer and one or more geographical areas from a plurality of geographical areas; b) receiving collectible inventory data from a qualified dealer of the plurality of qualified collectible dealers relating to at least one collectible available for a transaction through the online website; and c) responsive to receipt of the collectible inventory data for the at least one collectible, offering the at least one collectible for involvement in a transaction through the online website for a preset period of exclusivity and communicating the assignment of an authenticity insurance policy covering the at least one collectible, wherein the insurance policy insures the at least one collectible as being authentic.

In some embodiments, the aforementioned process further includes the step of receiving dealer data includes comparing the information qualifying the dealer as a collectible expert with qualifying criteria.

In some embodiments, the aforementioned process further includes the step of storing the dealer data received in a database.

In some embodiments, the aforementioned process further includes the step of prioritizing each qualified dealer within each one of the geographical area.

In some embodiments, the aforementioned process further includes the step of receiving collectible inventory data from a qualified dealer of the plurality of qualified collectible dealers relating to at least one collectible available for a transaction through the online website further comprises the step of receiving a selection of one of an auction of the collectible and a sale at a fixed price.

In some embodiments, the aforementioned process further includes the step of receiving collectible inventory data from a qualified dealer of the plurality of qualified collectible dealers relating to at least one collectible available for a transaction through the online website further comprises the steps of: receiving collectible input data from a user relating to an unauthenticated collectible, including an indication of a geographical area; identifying qualified dealer based on the geographical area of the qualified dealer; and communicating the collectible input data to the identified qualified dealer.

In some embodiments, the aforementioned process further includes the steps of: receiving collectible inventory data from the identified qualified dealer including the unauthenticated collectible, wherein the inclusion of the unauthenticated collectible in the inventory data indicates that the collectible is authenticated; and receiving a selection of one of an auction of the collectible and a sale at a fixed priced.

Some embodiments of the invention are directed to a method of facilitating transactions involving collectibles through an online website comprising the steps of: a) receiving dealer data relating to a plurality of collectible dealers, wherein the dealer data for each collectible dealer includes information qualifying the dealer as a collectible expert for one or more categories of collectibles selected from a plurality of preset categories of collectibles and an association between the dealer and one or more geographical areas from a plurality of geographical areas; b) receiving collectible inventory data from a qualified dealer of the plurality of qualified collectible dealers relating to at least one collectible available for a transaction through the online website; and c) responsive to receipt of the collectible inventory data for the at least one collectible, offering the at least one collectible for involvement in a transaction through the online website for a preset period of exclusivity and communicating the assignment of an authenticity insurance policy covering the at least one collectible, wherein the insurance policy insures the at least one collectible as being authentic.

In some embodiments, the aforementioned method further includes the step of receiving dealer data includes comparing the information qualifying the dealer as a collectible expert with qualifying criteria.

In some embodiments, the aforementioned method further includes the step of storing the dealer data received in a database.

In some embodiments, the aforementioned method further includes the step of prioritizing each qualified dealer within each one of the categories of collectibles.

In some embodiments, the aforementioned method further includes the step of prioritizing each qualified dealer within each one of the geographical area.

In some embodiments, the aforementioned method further includes the step of receiving collectible inventory data from a qualified dealer of the plurality of qualified collectible dealers relating to at least one collectible available for a transaction through the online website further comprises the step of receiving a selection of one of an auction of the collectible and a sale at a fixed price.

In some embodiments, the aforementioned method further includes the step of receiving collectible inventory data from a qualified dealer of the plurality of qualified collectible dealers relating to at least one collectible available for a transaction through the online website further comprises the step of receiving an indication from the dealer that the collectible is authenticated.

In some embodiments, the aforementioned method further includes the step of receiving collectible inventory data from a qualified dealer of the plurality of qualified collectible dealers relating to at least one collectible available for a transaction through the online website further comprises the steps of: receiving collectible input data from a user relating to an unauthenticated collectible, including an indication of a geographical area; identifying qualified dealer based on the geographical area of the qualified dealer; and communicating the collectible input data to the identified qualified dealer.

In some embodiments, the aforementioned method further includes the step of communicating a consignment form to the user.

In some embodiments, the aforementioned method further includes the step of receiving notification indicating that the unauthenticated collectible is authenticated by the identified qualifying dealer.

In some embodiments, the aforementioned method further includes the steps of: receiving collectible inventory data from the identified qualified dealer including the unauthenticated collectible, wherein the inclusion of the unauthenticated collectible in the inventory data indicates that the collectible is authenticated; and receiving a selection of one of an auction of the collectible and a sale at a fixed priced.

In some embodiments, the communication between the user and qualified dealer is facilitate through the online website. Communication between users and other users may be facilitated through the online website. Any communication may be compared with a preset filtering criteria, the preset filtering criteria identifying text to be removed from the communication, which may involve the steps of comparing each communication with the preset filtering criteria and removing text responsive to identifying text to be removed.

In some embodiments, the aforementioned method further includes the step of storing information relating to the collectible and insurance policy in a collectible registry.

Some embodiments of the invention are directed to a system for facilitating transactions involving collectibles comprising: a) one or more communication devices configured for: i) receiving dealer data relating to a plurality of collectible dealers, wherein the dealer data for each collectible dealer includes information qualifying the dealer as a collectible expert for one or more categories of collectibles selected from a plurality of preset categories of collectibles and an association between the dealer and one or more geographical areas from a plurality of geographical areas; ii) receiving collectible inventory data from a qualified dealer of the plurality of qualified collectible dealers relating to at least one collectible available for a transaction through the online website; and b) one or more processing devices configured for facilitating the step of: responsive to receipt of the collectible inventory data for the at least one collectible, offering the at least one collectible for involvement in a transaction through the online website for a preset period of exclusivity and communicating the assignment of an authenticity insurance policy covering the at least one collectible, wherein the insurance policy insures the at least one collectible as being authentic.

In some embodiments, the communication devices are connected with the Internet. The communication devices may also be configured to provide an online website or computer application for downloading onto a mobile platform. The communication devices may be configured for displaying one or more graphical user interfaces on remote display devices.

The aforementioned system of the invention may further include one or more data storage devices for storing information regarding the dealer data and authenticated collectibles. The one or more processing devices may be further configured to initiate an auction or sale of an authenticated collectible.

Some embodiments of the invention are directed to a method of facilitating transactions involving collectibles comprising the steps of: a) storing dealer data in a data storage device relating to a plurality of collectible experts, wherein the stored dealer data for each collectible expert includes an association with one or more categories of collectibles from a plurality of preset categories of collectibles and an association with one or more geographical areas; b) receiving collectible inventory data, wherein the inventory data relates to at least one collectible displayed on a remote display device in connection with an offered for sale or auction thereof through a global communication network; and c) responsive to receipt of the collectible inventory data for the at least one collectible, displaying the at least one collectible as available in a transaction through the online website for a preset period of exclusivity and communicating the assignment of an authenticity insurance policy covering the at least one collectible, wherein the insurance policy insures the at least one collectible as being authentic and the transaction is one of an auction or a fixed price sale.

In some embodiments, the aforementioned method further includes the steps of receiving collectible inventory data from a qualified dealer of the plurality of qualified collectible dealers relating to at least one collectible available for a transaction through the online website further comprises the steps of: receiving collectible input data from a user relating to an unauthenticated collectible, including an indication of a geographical area; identifying qualified dealer based on the geographical area of the qualified dealer; and communicating the collectible input data to the identified qualified dealer.

In some embodiments, the aforementioned method further includes the step of receiving notification indicating that the unauthenticated collectible is authenticated by the identified qualifying dealer.

In some embodiments, the aforementioned method further includes the steps of: receiving collectible inventory data from the identified qualified dealer including the unauthenticated collectible, wherein the inclusion of the unauthenticated collectible in the inventory data indicates that the collectible is authenticated; and receiving a selection of one of an auction of the collectible and a sale at a fixed priced.

Some embodiments of the invention are directed to computer program products, non-transitory media and downloadable applications, or the like, which include code and data, among other things, for executing, enabling, providing or facilitating any of the methods and processes disclosed herein, or which are equivalent thereto, on any computing device.

### BRIEF DESCRIPTION OF THE FIGURES

FIG. 1 is a schematic drawing illustrating how a system in accordance with some embodiments of the invention would be configured;

FIG. 2 is a flowchart illustrating a method for receiving dealer information and qualifying dealers configured in accordance with some embodiments of the invention;

FIG. 3 is a flowchart illustrating a method for qualified dealers to sell or auction collectibles configured in accordance with some embodiments of the invention;

FIG. 4 is a flowchart illustrating a method for users/collectors to purchase collectibles offered for sale or auction and an escrow process configured in accordance with some embodiments of the invention;

FIG. 5 is a flowchart illustrating a method for users/collectors to submit collectibles for authentication and sale or auction configured in accordance with some embodiments of the invention;

FIG. 6 is a flowchart illustrating a method for providing a protective filter of user messages configured in accordance with some embodiments of the invention; and

FIG. 7-10 are schematic diagrams illustrating information being collected for purposes of providing recommendations to users of the system of the invention.

### DETAILED DESCRIPTION OF THE INVENTION

The embodiments of the invention discussed herein are generally related to systems and methods for facilitating and outfitting an online hub and destination center for activity involving collectibles.

Much of the inventive functionality and principles are best implemented by, with or in software programs, instructions and applications, operating in connection with various computer hardware, such as data input/output devices, data processing devices and data storage devices. It is expected that one of ordinary skill, notwithstanding the many design choices motivated by, for example, available time, current technology, and economic considerations, when guided by the concepts and principles disclosed herein will be readily capable of generating such software and selecting appropriate hardware with minimal experimentation. Therefore, in the interest of brevity and minimization of any risk of obscuring the principles and concepts according to this embodiment of the invention, further discussion of such software and hardware, if any, will be limited to the essentials with respect to the principles and concepts used by the preferred embodiments.

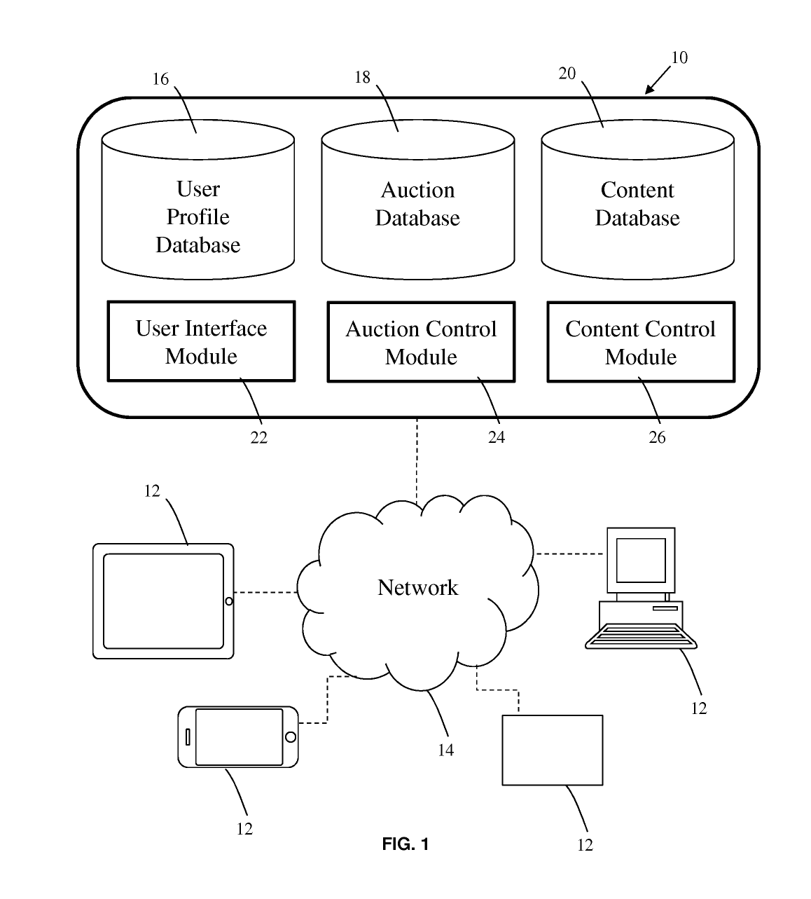

Referring to FIG. 1, a high-level schematic is shown of a system 10 constructed in accordance with an embodiment of the invention might be configured. In operation, one or more user devices 12 would communicate over any communication network 14 with system 10. User devices 12 could include desktop computers, laptop computers, tablet computers, e-readers, mobile/smart phones, gaming devices, personal digital assistants (PDA's), televisions, and other network-enabled media display devices. Network 14 could comprise the internet, satellite or other communication networks, and communication with the user devices 12 could be through a wireless, cellular or hardwire connection, or a mixture thereof. Only a few user devices 12 are shown in FIG. 1 in order to simplify and clarify the description, but it is contemplated that tens of thousands or more of such devices could be communicating over the network 14 with system 10. Further, in one embodiment, there could be multiple systems 10 in communication with each other and working together.

System 10 may include various databases and modules which may be either integrated or in communication with one another to enable various applications, functionality and features, such as those discussed herein. For illustrative purposes, system 10 of FIG. 1 is shown in block diagram as including a user profile database 16, an auction database 18, a content database 20, a user interface module 22, an auction control module 24 and a content control module 26. In other embodiments, system 10 may include additional, fewer, or different modules for various applications. Conventional components such as network interfaces, security mechanisms, load balancers, failover servers, management and network operations consoles, and the like are not shown so as to not obscure the details of the system, but are contemplated as possible additional components of system 10.

User interface module 22 provides, or causes to be provided, a user interface between system 10 and one or more of devices 12. The user interface can be any type of user interface, such as a graphical user interface (GUI) or a web-based user interface (WUI). Such a user interface allows a user to register, login, create or edit a user profile, conduct searches in user profile database 16, auction database 18 or content database 20, including searches for collectibles either owned by other users or offered for auction, access media content, engage in social networking and otherwise interface with system 10. GUIs may be employed which incorporate user-friendly features and fit seamlessly with other operating system interfaces, that is, in a framed form having borders, multiple folders, toolbars with drop or pull-down menus, embedded links to other screens and various other selectable features associated with animated graphical representations of depressible buttons. These features can be selected (i.e., “clicked on”) by the user via connected mouse, keyboard, touch screen or other commonly used tool for indicating a preference in a computerized graphical interface.

Auction control module 24 controls transactions between parties, including users, involving the consigning, trading, purchase, sale or auctioning of collectibles involving various users. Auction control module 24 interacts with the auction database 18, which stores information related to the various collectibles available for auction and associated data, such as historical information, dealer information, price, registration information, appraisal values, insurance information, title guarantee information, and other such details as might typically be associated with real-world purchase, sale and auction transactions. Auction control module 24 utilizes this data to manage requests made by users to engage in a transaction involving a collectible.

Content module 26 acts as a gateway between the various users of system 10 and the various databases, including databases 16, 18 and content database 20, which stores the various media content collected from users or other sources. Content database 20 may also store information relating to collectibles, including registry, title and chain of title information, which may be collected and displayed through GUIs presented through an online website. Content module 26 facilitates control and display of the stored media content. In one embodiment of the invention, the content control module 26 manages the process by which content is collected and delivered from and to users. In another embodiment, content control module 24 determines access to specific media content by determining whether to grant access to the specific stored media content in any of the databases, including content database 20. Content database 20 could store various forms of media content, including but not limited to, pictures, written posts, video clips, links to website, sound recordings, animations, and combinations and variations thereof.

A system such as system 10 may be configured to facilitate a plurality of features which incorporate methods as discussed herein below. For illustrative purposes, the methods described below will be described in connection with system 10 and components thereof. It should be readily apparent to one skilled in the art that this is for description purposes only and is not to be construed as limiting of the methods or invention in any way.

Much of the inventive functionality and many of the inventive principles described herein are best implemented with or in software programs and instructions. It is expected that one of ordinary skill, notwithstanding possibly significant effort and many design choices motivated by, for example, available time, current technology, and economic considerations, when guided by the concepts and principles disclosed herein will be readily capable of generating such software instructions with minimal experimentation. Therefore, in the interest of brevity and minimization of any risk of obscuring the principles and concepts according to the present invention, further discussion of such software, if any, will be limited to the essentials with respect to the principles and concepts used by the exemplary embodiments.

For example, technologies used in the exemplary embodiments disclosed herein may include: AJAX (shorthand for asynchronous JavaScript and XML), is a group of interrelated web development techniques used on the client-side to create interactive web applications. With Ajax, web applications can retrieve data from the server asynchronously in the background without interfering with the display and behavior of the existing page. The use of Ajax techniques has led to an increase in interactive or dynamic interfaces on web pages. Data is usually retrieved using the XMLHttpRequest object. Despite the name, the use of XML is not actually required, nor do the requests need to be asynchronous; Ruby on Rails is an open source web application framework for the Ruby programming language. It is intended to be used with an Agile development methodology that is used by web developers for rapid development; MySQL is a relational database management system (RDBMS) that runs as a server providing multi-user access to a number of databases. Sphinx—a free software search engine designed with indexing database content in mind. It currently supports MySQL. Other data sources can be indexed via pipe in a custom XML format. It is distributed under the terms of the GNU General Public License version two or a proprietary license. This search engine features high indexing speeds (up to 10 MB/s on high-end CPUs), high search speeds and high scalability.

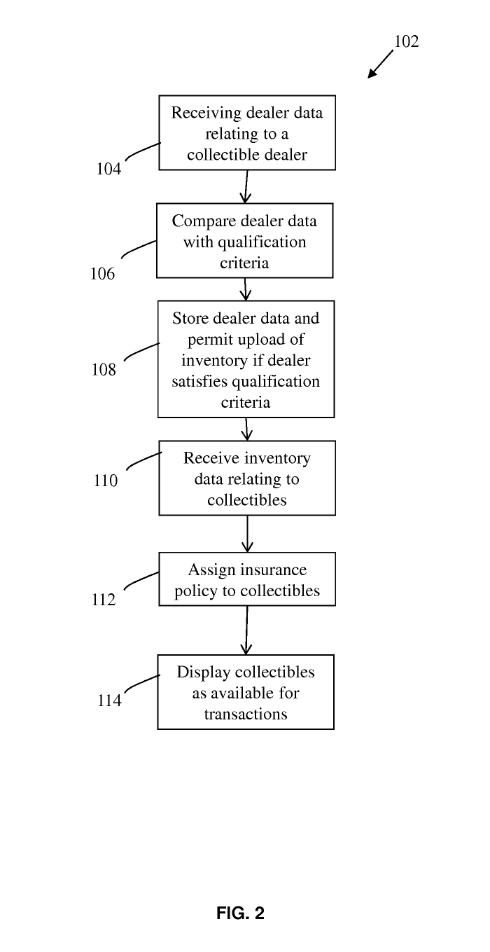

FIGS. 2-6 through provide methods which may be at least partially, if not wholly, facilitated through GUIs provided by through an online website or mobile application in communication with the Internet or global communication network.

FIG. 2 illustrates a method 102 for qualifying and storing information regarding collectible dealers who are capable of functioning as experts for one or more categories of collectibles, and assigning authentication insurance for an inventory of collectibles made available for transactions through an online site provided by system 10 by a qualified collectible dealer.

As shown by step 104, system 10 receives information in one of the system 10 databases regarding a collectible dealer, also referred to herein as dealer data. The dealer data may include a variety of information, such as general personal information and address, as well as specific information relating to the dealer's knowledge of collectibles and qualifications as an expert or appraiser of collectibles.

As shown be step 106, the dealer data received regarding the collectible dealer will be reviewed and compared to determine if the dealer meets all qualification criteria to be identified as an expert in one or more categories of collectibles. The qualification criteria may consider a variety of factors of varying weight and sufficiency which may relate to the reliability and legitimacy of the dealer for purposes of assessing liability of identifying the dealer as an expert, including background checks, criminal history checks, credit checks, regulatory approvals if applicable, licensure as an appraiser, litigation history, years of experience, existing collectible inventory, among other things. In some embodiments, the qualification criteria may also include affirmations or acceptance of obligations, such as those relating to ensuring the integrity of the system and method of the invention. In some embodiments, system 10 may assign a hierarchy to each qualified dealer or otherwise identify a qualified dealer within a particular geographical area as a “master dealer” with subsequent dealers being qualified either by system 10 or the master dealer, or both, with the non-master dealers operating within the same area under the purview and scope of a qualified master dealer.

As shown by step 108, upon satisfaction of the qualification criteria the dealer data received in step 104 is stored in a system 10 database. System 10 then permits the qualified dealer to upload data relating to an inventory of collectibles to be approved and displayed on GUIs as available for transactions with users, who may be collectors or other dealers for example, accessing the online site provided by system 10, including auctions, trades and instant purchases.

As shown by step 110, system 10 receives the inventory data from the qualified dealer, which may include any relevant information relating to the collectible, such as descriptive information regarding each collectible, in order to facilitate categorization and search features provided to users of the online site, as well as ownership information, chain of title or transfer history and a desired sales price or auction limits, such as a reserve or minimum price. The inventory data received will be stored by system 10 and can be associated with a dealer profile from which the data is received.

In some embodiments, the qualified dealer must pre-authenticate each collectible in the inventory prior to the inventory being approved for display. System 10 may require an affirmative indication that the inventory has been fully authenticated upon uploading, such as selectively checking a checkbox or entering a response to a query in a data field in a GUI.

In step 112, insurance policy information is assigned or otherwise associated with each collectible in the inventory. The insurance policy insures that the collectible is authentic as described, such that a subsequent purchaser of an insured collectible through system 10 will be able to submit a claim if the purchased collectible is discovered to be a fake.

In some embodiments, system 10 may store policy information for each collectible in a database and/or in connection with a profile stored in user profile database 16. System 10 may also create an entry to store in a registry of collectibles maintained in a database such as database 20, including information relating to the affirmation of authentication by the dealer, assignment of the insurance policy, and all other information provided in the inventory data. The registry entry may thereafter be updated as necessary to track the chain of title for authenticated collectibles and facilitate insurance claims, if any, among other things.

As shown by step 114, collectibles in the inventory data are displayed as available for transactions through the online site and including an indication that the collectible has been authenticated by an expert with that authentication being insured through an insurance policy.

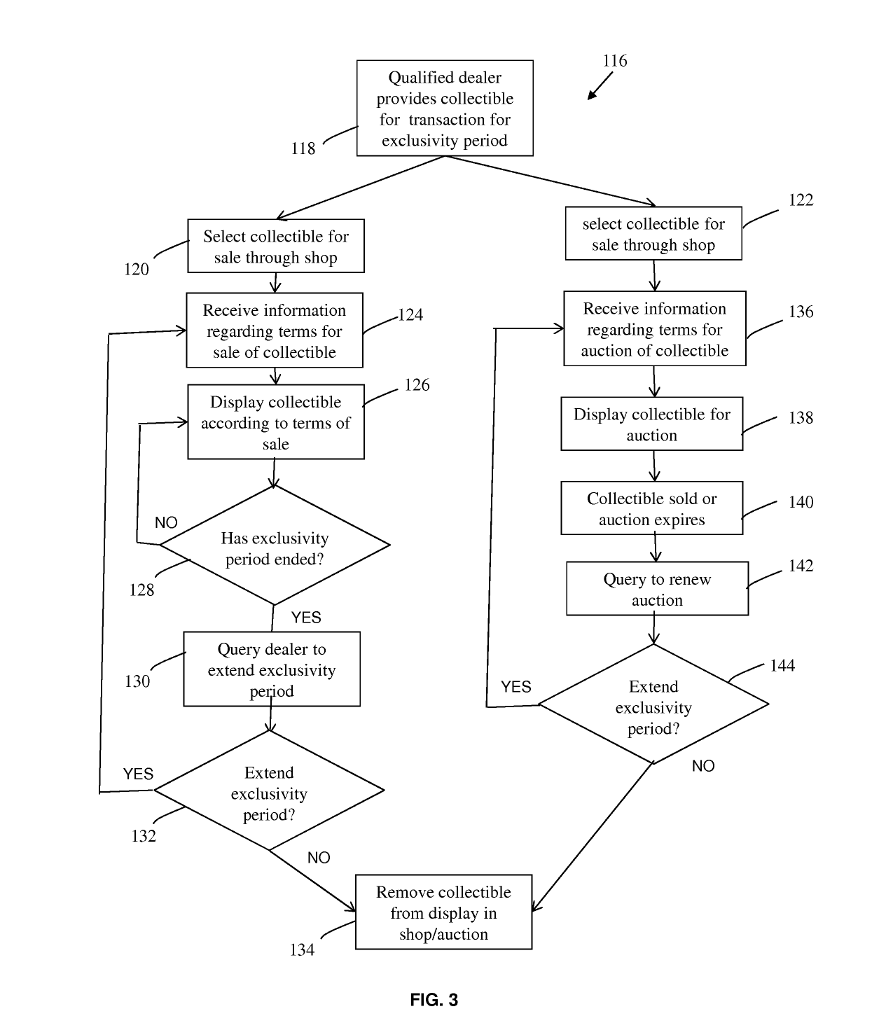

FIG. 3 illustrates a method 116 for dealers to manage their inventory. Subsequent to the inventory being uploaded, system 10 may require the dealer to make each collectible item available for a transaction exclusively through the online site for a preset period of time. Each collectible item uploaded and received by system 10 in step 118 may be selectively made available for either sale at a set price through an online shop in step 120 or auction in step 122.

As shown by steps 124 and 126, system 10 of this embodiment will require entering information relating to the collectible to be offered in the shop, such as the sale price and exclusivity period, which will be received by system 10 prior to the collectible being displayed as available for sale in the online shop. The exclusivity period may have a preset range, such as three to ninety days for example, which will be stored in memory. System 10 may provide GUIs with queries and corresponding data fields, drop down menus or checkboxes to facilitate transmittal and receipt of information by qualified dealers in step 124.

As shown by step 128, system 10 periodically, which may be daily, conducts a check of whether the exclusivity period as set in step 124 has concluded for any collectible items not sold and remaining available for sale. If the exclusivity period has not yet concluded, then the item will remain available in step 126. If the exclusivity period is determined to have concluded in step 128, system 10 will query the dealer having submitted the collectible for sale in step 130 as to whether the exclusivity period should be extended or renewed. The query may be sent to the dealer via any communication method, such as email or message to an inbox associated with the dealer's profile stored in profile database 16. If the response to the query in step 130 is receipt of an extension to the exclusivity period in step 132, then the dealer is provided with the opportunity to reset or change fields in step 124 before the item will return to the shop in step 126. The collectible will remain for sale in the shop until the renewed exclusivity period ends as shown by step 128. In some embodiments, the dealer may set the exclusivity period as being until the collectible is sold in step 124 or extend the exclusivity period as being until the collectible is sold in response to the query sent in step 130. If the exclusivity period is not renewed or extended in response to query step 132 then the item is removed from the shop in step 134. In some embodiments, the item may be placed in the shop without extending the exclusivity period.

Should the dealer select to offer the collectible item for auction during the exclusivity period then system 10 of this embodiment will require receiving auction related information in step 136 such as the start time, end time and reserve amount for the item at auction. System 10 may compare the start time and end time with a preset exclusivity period to determine whether the auction time is at least equal to or greater than the preset exclusivity period.

Upon receipt of acceptable information in step 136, the collectible will be put up for a live auction conducted through the online site and displayed by GUIs as shown by step 138. As shown by step 140, either the item is sold at auction or the auction time reaches the end time set in step 136 without the item being sold. If the item is not sold, then system 10 will query the dealer in step 142 as to whether the auction should be renewed, in the manner described above. If receipt of response indicating the auction is renewed is not received in step 144, then the dealer will be able to set auction related information in step 136. If the auction is not renewed as a result of step 144, then the collectible item will be removed from auction in step 134.

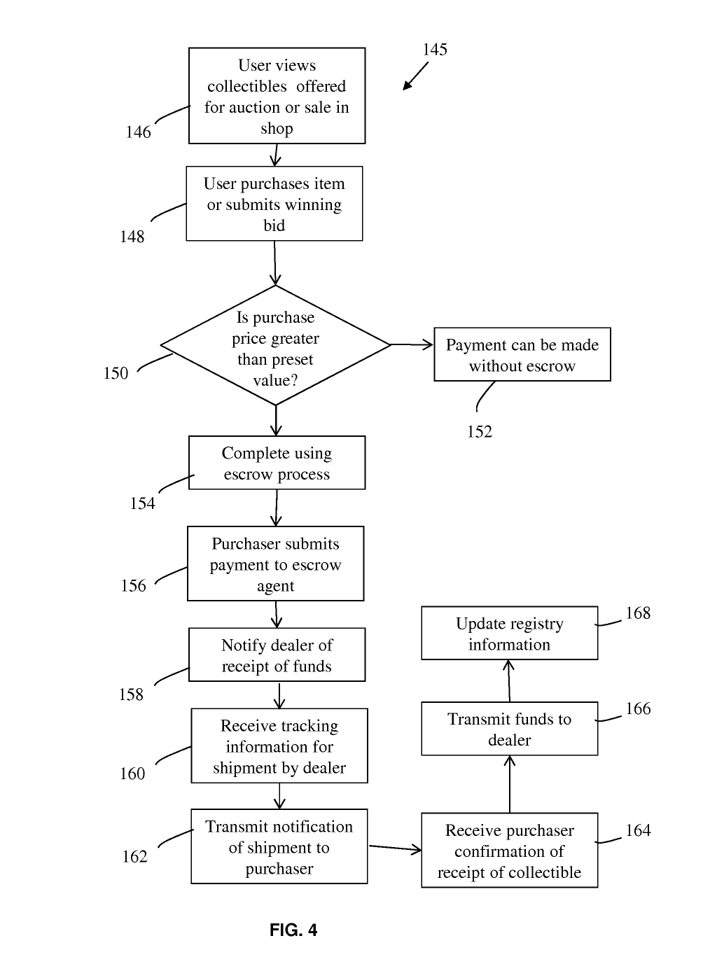

FIG. 4 illustrates a method 145 for completing a transaction involving a collectible through an online site provided by system 10.

As shown by step 146, a user may view collectibles made available for sale through the online shop in step 126 or auction in step 138. The user may engage in a purchase for the collectible in step 148 by purchasing the item from the store at a fixed price or submitting the winning auction bid. In some embodiments, the purchasing user may affirm acknowledgement of the authentication insurance policy provided in connection with the collectible, through a checkbox or data entry field. The user may be required to submit personal information which may be added to the registry information stored by system 10 for the collectible along with the transaction information.

In some embodiments, a transaction may be facilitated through an escrow process involving an escrow agent which is integrated in the online site. In this embodiment, the purchase price for the collectible involved in the transaction is compared with a preset value to determine whether the escrow process will be required as shown by step 150. If the purchase price is either equal to or less than the preset value, then no escrow process is required and payment may be processed according to conventional payment methods without escrow as shown in step 152. If the purchase price is greater than the preset value, then the transaction may be completed via the escrow process as shown in step 154. Step 154 may also require that purchasers affirmatively indicate acceptance of the escrow arrangement through a checkbox, button or data field. In step 156, purchasing users will pay the purchase price to an escrow agent which will confirm receipt to the dealer of the funds for the purchase of the collectible in step 158. Upon receiving notification of the receipt of payment, the dealer will then complete a transfer of the collectible to the buyer by shipping the item and notify system 10 of the tracking information for the shipment in step 160, which will be received and conveyed to the purchaser in step 162. The purchaser will confirm receipt of the collectible to system 10 in step 164 which will be received and conveyed to the escrow agent, thus triggering release of the funds from the escrow agent to the seller/dealer in step 166. In step 168, system 10 may update the stored registry information including the chain of title associated with the collectible to identify the new owner.

The insurance policy is associated with the collectible and as such the purchaser of the collectible would benefit from the same insurance policy, which would pay the new owner should a claim be submitted in which it is shown that the collectible has been proven to be inauthentic. In some embodiments, the insurance policy may be automatically provided to the purchaser. Claims relating to the insurance policy may be submitted through system 10.

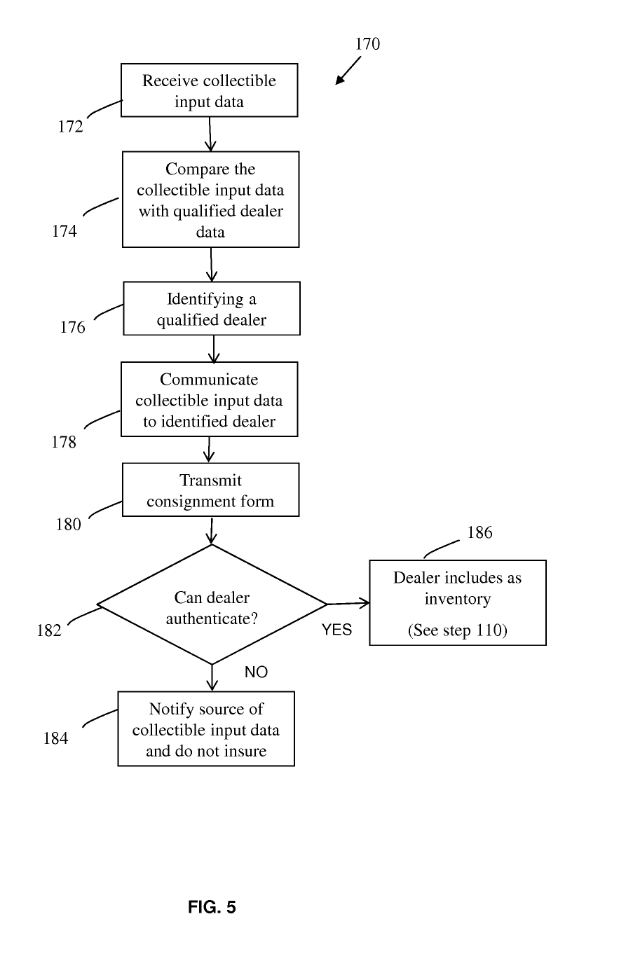

FIG. 5 illustrates a method 170 by which site users who are not qualified dealers may submit collectibles for authentication and transactions through the site.

In step 172, system 10 receives collectible input data from a user device 12 regarding a collectible to be considered for authentication and a transaction through the online site. The collectible input data can include any relevant information relating to the collectible for purposes of categorizing the collectible, as well as ownership information, a geographical location of the item and/or owner, chain of title or transfer history and a desired sales price or auction limits, such as a reserve or minimum price. The collectible input data will be stored by system 10 and can be associated with a user profile.

System 10 may also facilitate receipt of the input data of a desired content or form by communicating or providing a collectible input data form or GUI through the online website which can be displayed on user devices. The form may include various queries for information, fields for data entry, drop down menus and a button or actuator for transmitting the form to system 10 when completed. The form may also allow for the user to identify the category of the collectible.

In this embodiment, the category is selected by the user and submitted with the input data. As shown by steps 174 and 176, the category of the collectible is compared with the qualified dealer data stored in step 108 to identify a dealer associated with the category at a proximal geographical location relative to the source of the collectible input data, that is, the owner of the collectible. In some embodiments, system 10 may identify only those dealers identified as master dealers within the geographical area associated with the owner of the collectible, and the master dealer may subsequently identify or otherwise rely upon the expertise of a non-master dealer in the geographical area and within the purview of the master dealer.

As shown in step 178, the collectible input data is communicated to the identified dealer and the identified dealer information is communicated to the source of the collectible input data. System 10 may further facilitate communication between the source of the input data and the identified dealer through a messaging system provide by the site.

Should the dealer authenticate the collectible, the dealer may then add the collectible as part of the dealer's inventory, resulting in the application of the insurance coverage to the collectible and its inclusion in the registry of stored information relating to collectibles. The registry entry is thereafter updated as necessary to track the chain of title for authenticated collectibles, among other things. As shown in step 180, the user may be provided with a consignment form containing the terms by which a dealer will offer the collectible as part of the dealer inventory in a transaction through the online site during an exclusivity period as shown in FIG. 3. As shown in steps 182 and 184, should the dealer be unable to authenticate the collectible, the user will be notified and the failure to authenticate the collectible may also be stored in the registry. In this embodiment, a collectible which is not authenticated is not insured and not permitted to be involved in transactions. In other embodiments, non-authenticated collectibles may not be insured but allowed to be involved in transactions in a separate portion of system 10. As shown by steps 182 and 186, if the dealer is able to authenticate the collectible, it may then be included in the dealer inventory as set forth in method 102 beginning with step 110, and subsequently offered for sale or auction as set forth by method 116. Collectibles which have been included in the inventory of a qualified dealer will be insured by system 10 for any subsequent transaction.

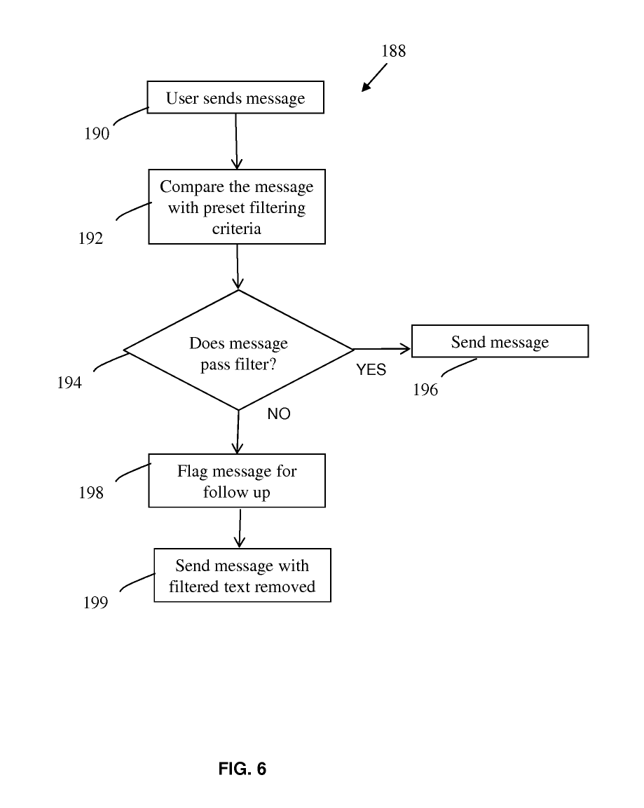

To better protect its users and the integrity of the system, each user, including dealers, is allowed to register and create a password protected profile with messaging capability, including inbox, outbox and storage, wherein the messages are stored and monitored via a method 188 shown in FIG. 6. In step 190, a user sends a message through the site to another user. The text of the message is compared with preset filtering criteria in step 192 to identify any text to be filtered from the message. Forbidden text may include any violations of the terms of service or text which either indicates or suggests that an offer for sale outside of the online shop or auction is being made, including exchanging contact information such as an external email address or phone number which may be used to circumvent the protections provided by the site. The preset filtering criteria may be stored in a separate database. Should the message pass the preset filtering criteria in step 194 without removal of any text then the message will be sent in step 196. If the text is filtered as a result of step 192, then the message will be flagged by system 10 for follow up in step 198 and the message will be sent with the filtered text removed in step 199.

The user profiles of system 10 provide for social networking and the ability for collectors to create user profiles with information about themselves, their collections and interests, which is stored by system 10. Users may connect profiles or information on those profiles to other existing social media platforms. For example, system 10 may include a link or virtual button to actuate the posting to other social media platforms of pictures of collectibles, which they or others own, or are available for sale or auction through the system and aforementioned methods of the invention. Users may also post information about a collectible on a user profile and then actuate a link or virtual button to forward the information about a collectible as collectible input data in step 172 to begin the process of authenticating and insuring the collectible for a transaction through system 10, which can be completed as set forth by method 170. Accordingly, users may create a personal self-profile, post pictures of collectibles, including collectibles which have been authenticated and insured for sale or auction through the site, and make use of an automated online consignment process where a user's collectible is authenticated by a dealer established as an expert in the relevant category of the collectible and the authenticity of the collectible is thereafter insured by an established insurer

System 10 may include a celebrity collectible space in which celebrities may have profiles or otherwise display collectibles they own, as well as offer collectibles for sale or auction. Celebrities may offer collectibles owned by them or autographed items or memorabilia, all of which may be included in transactions in the manner discussed above, and as shown by method 116 in some embodiments.

System 10 may further include educational spaces for users to discuss collectibles and trade information, as well as provide forums for users, experts and celebrities to share information and educate. Accordingly, the invention exemplified by system 10 integrates networks which collectively create a hub for appraising, authenticating, and insuring the authenticity of collectibles in the buying and selling of collectibles, sharing information about collectibles and collections, and learning about collectibles of all categories.

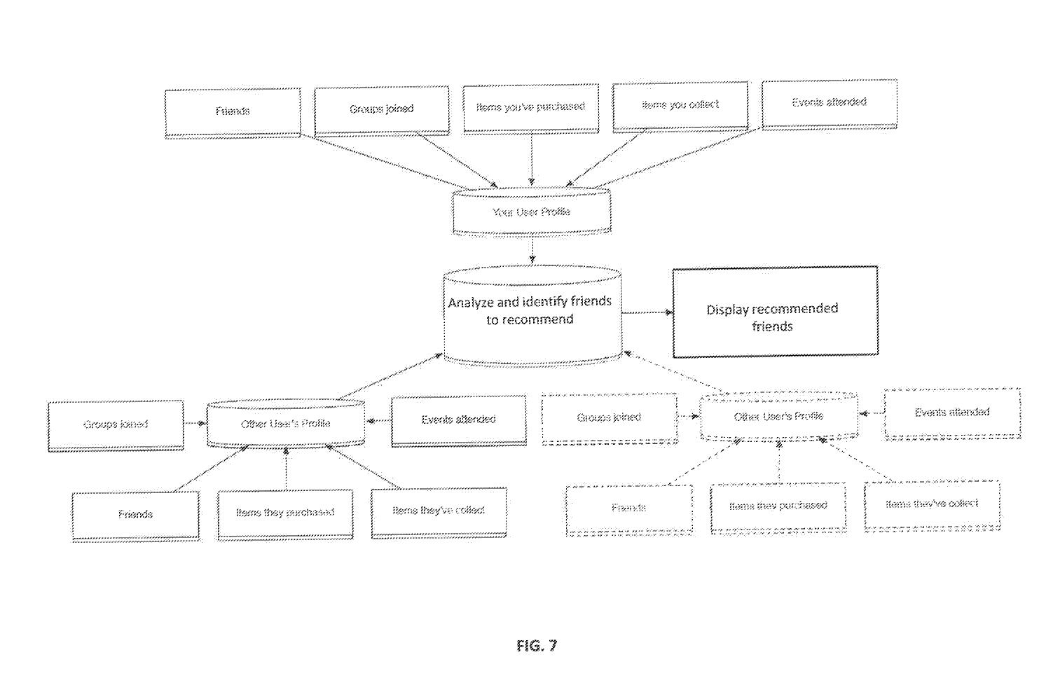

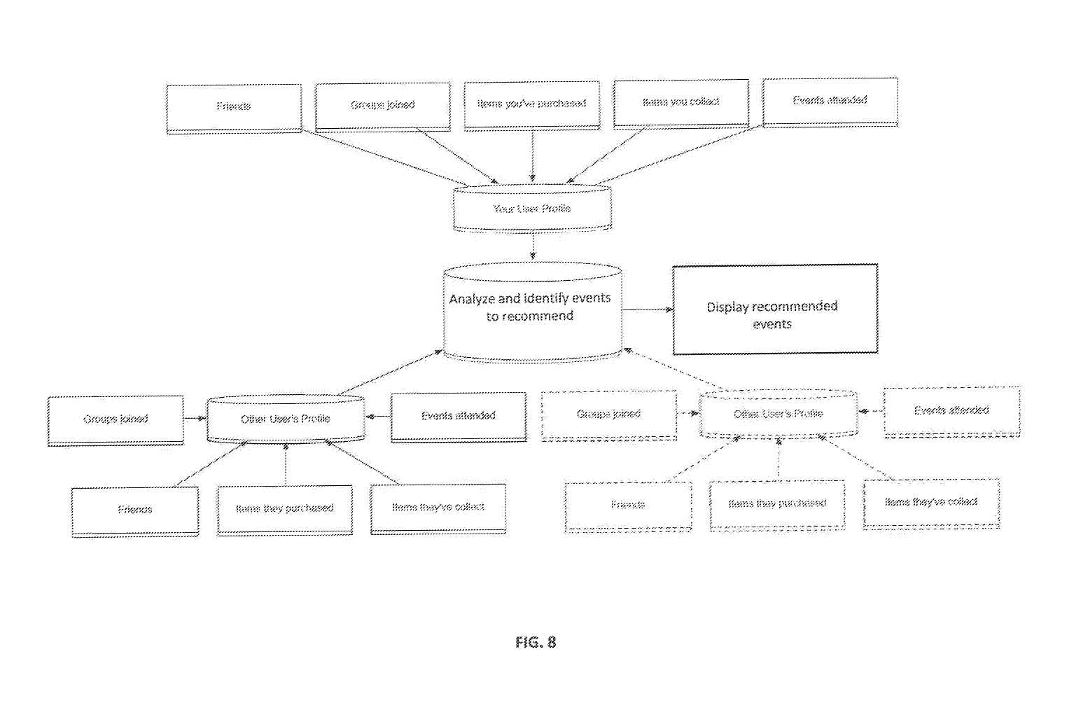

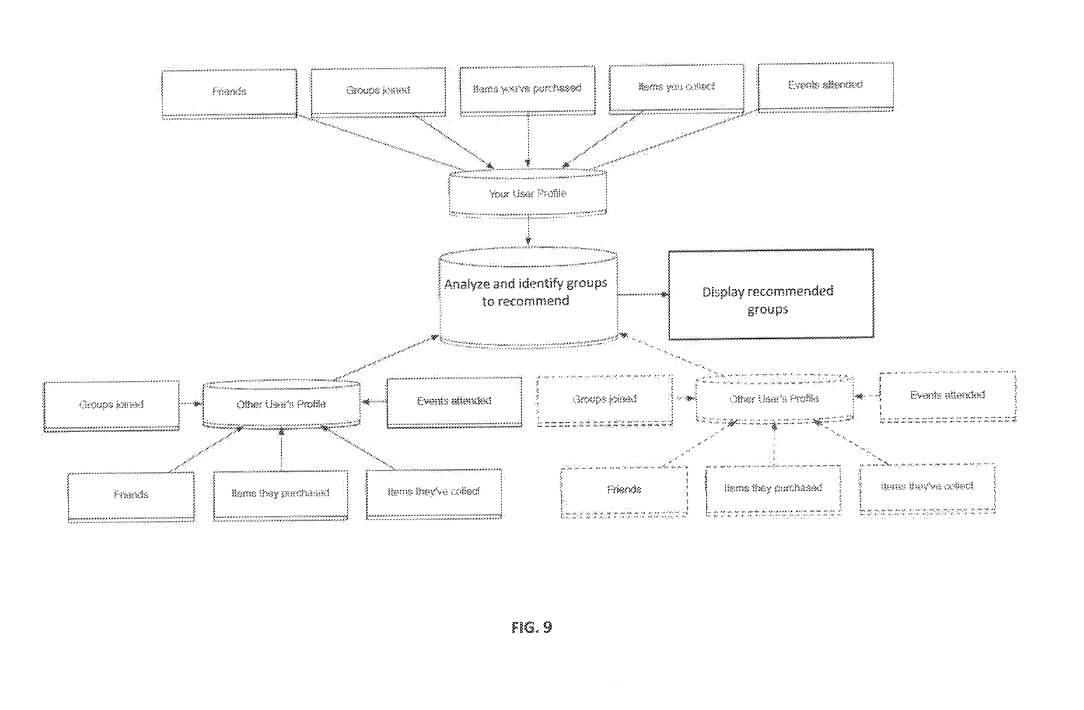

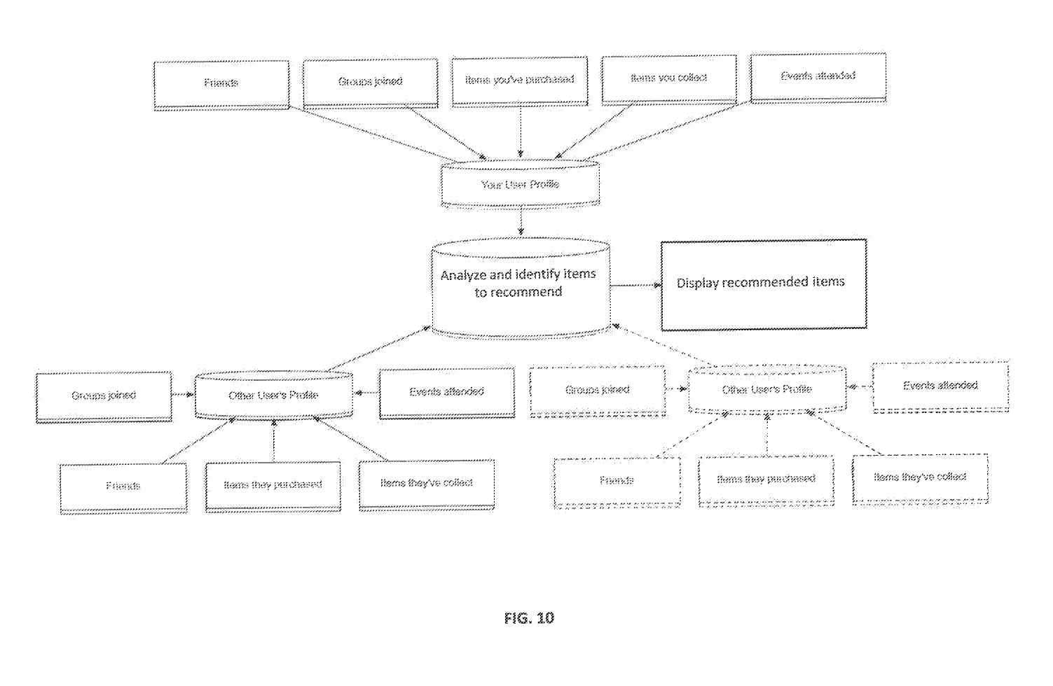

In addition to information uploaded or entered into system 10 by users, system 10 may track and collect user activity, such as groups joined, items purchased, items collected, events attended, and use similar information tracked and collected from other users connected as friends or associates. This information may be analyzed by one or more processing devices associated with system 10 to identify and recommend friends, events, groups, or items which may be of interest based on the analysis, as shown schematically in FIGS. 7-10.

Analyses for identifying and providing recommendations may be facilitated by an analytics module configured to receive user information and activity data and employ one or more processing devices, algorithms and recommender systems, including collaborative, content-based or other filtering and scoring techniques and protocols and/or other processing methods for analyzing, refining or filtering user input, activity and/or search results and assigning a score for purposes identifying recommendable content.

The analytics module may use information from a user's profile to make predictions regarding other collectibles that might interest the user. Data used in the recommendation system may be obtained through the use of explicit collection (i.e., data collected from users who, for example, are directly rating items, such as collectibles or collections, ranking items, stating preferences, listing favorites or least favorites, etc.) and implicit collection (i.e., data collected as, for example, a byproduct of user behavior, such as collectibles viewed or purchased, user profiles viewed, topics searched and collectible information reviewed). The collected data may be compared to similar data collected from others in order to calculate a list of recommended items for a user.

Recommendations may be generated for display based upon each keystroke the user enters and may be cached locally on the user device. Updates may also be provided to the cache memory by system 10 without requiring a user keystroke. Additional suggestions may be supplied to users by ranking content based upon popularity, the frequency of query activity, frequency within content, the acceleration of the frequency of content, the frequency of views or purchases of certain user profiles or collectibles, as well as any changes that occur to any of these metrics.

The collaborative filtering scoring techniques employed by the analytics module may include a two-step process. During the first step, other users are identified who have similar rating patterns as those of the active user. Secondly, the ratings obtained from these similar users provide the empiric basis for predicting information of relevance to the active user. The collaborative filtering can be both an inclusive and an exclusive process, gathering relevant information for users or removing incongruent information from the predictive information set.

Collaborate filtering procedures that uses a “training data set” based upon previous user behavior to predict a variable of interest to members of a target data set comprised of new users, such as such as the K-nearest neighbor algorithm may also be employed. In addition to user preference data, the training data set may have additional predictor variables, such as might be contained in a collector characteristics database (e.g., age, income, collections, interests, etc.). Variables of interest may include type of product purchased, amount of purchase, and so forth.

For example, in performing collaborative filtering, the analytics module may employ user rating data to compute similarity between users or items, with the value of ratings user ‘u’ gives to item ‘i’ is calculated as an aggregation of some similar users rating to the item:

r_{u,i}=aggr_{u′εU}r_{u′,i}

where ‘U’ denotes the set of top ‘N’ users that are most similar to user ‘u’ who rated item ‘i’. Some examples of the aggregation function includes:

$${r}_{u , i} = \frac{1}{N} {\sum }_{{u}^{′} ∈ U} {r}_{{u}^{′} , i}$$

$${r}_{u , i} = k {\sum }_{{u}^{′} ∈ U} simil ( u , {u}^{′} ) {r}_{{u}^{′} , i}$$

$${r}_{u , i} = \overline{{r}_{u}} + k {\sum }_{{u}^{′} ∈ U} simil ( u , {u}^{′} ) ( {r}_{{u}^{′} , i} - \overline{{r}_{{u}^{′}}} )$$

where k is a normalizing factor defined as

$$k = 1 / {\sum }_{{u}^{′} ∈ U} \vert simil ( u , {u}^{′} ) \vert$$

and rᵤ is the average rating of user u for all the items rated by that user.

Other methods that may also be used successfully for statistical clustering of user preference groups include the weighted majority, Bayesian prediction, factor analysis, and the Pearson correlation where two users x, y is defined as

$$simil ( x , y ) = \frac{{\sum }_{i ∈ {I}_{xy}} ( {r}_{x , i} - \overline{{r}_{x}} ) ( {r}_{y , i} - \overline{{r}_{y}} )}{\sqrt{{\sum }_{i ∈ {I}_{xy}} {( {r}_{x , i} - \overline{{r}_{x}} )}^{2} {\sum }_{i ∈ {I}_{xy}} {( {r}_{y , i} - \overline{{r}_{y}} )}^{2}}}$$

where I, is the set of items rated by both user x and user y.

The analytics module may also employ the cosine-based approach which defines the cosine-similarity between two users x and y as:

$$simil ( x , y ) = cos ( \vec{x} , \vec{y} ) = \frac{\vec{x} \cdot \vec{y}}{‖ \vec{x} ‖ \times ‖ \vec{y} ‖} = \frac{{\sum }_{i ∈ {I}_{xy}} {r}_{x , i} {r}_{y , i}}{\sqrt{{\sum }_{i ∈ {I}_{x}} {r}_{x , i}^{2}} \sqrt{{\sum }_{i ∈ {I}_{y}} {r}_{y , i}^{2}}}$$

In addition to, or instead of collaborative filtering, or other preferential treatment of various information as determined by other methods, non-preferential or objective type data may be employed to further target search results about the user of the site described herein. In some embodiments, the user information and activity data may be mined, associating, linked, extracted, or otherwise manipulated or used, and stored in a relational database.

Some embodiments of the invention are directed to systems and methods as described above which are wholly or partially provided through interactive television shows, satellite, cable or downloadable applications and may be supported, enabled or facilitated through components that may include various computer and network related software and hardware, that is, programs, operating systems, memory storage devices, data input/output devices, data processors, servers with links to data communication systems, wireless or otherwise, such as those which take the form of a local or wide area network, and a plurality of data transceiving terminals capable of interfacing with the network, such as personal computers, handheld devices, PDAs, cell phones or any other devices capable of displaying a user interface.

Those skilled in the art will appreciate that the particular types of communication network and devices, software and hardware are not vital to the full implementation of the embodiments described herein or other embodiments within the scope and spirit of the invention. It should be understood that the type of communication network and devices, software and hardware may also vary based on the rapid advances in technology that are ongoing in the industry. In other words, the precise software and hardware configuration of the various embodiments of the invention may vary accordingly while still remaining within the scope and spirit of the invention.

Although this description discloses exemplary embodiments including, among other components, software executed on hardware, it should be noted that the embodiments are merely illustrative and should not be considered as limiting. For example, it is contemplated that any or all of the hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

The system and methods of the invention may be used to provide a website through the Internet or otherwise accessible through a global communication network that will allow collectors everywhere to join a dynamic community where they will be able to share their collections and items with other collectors, put their collection for sale or auction, receive feedback on their items from other users and get their items appraised. All items for sale are appraised, insured and the title guaranteed, which is the first in the industry for items of this nature.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the disclosure herein and as set forth in the claims and equivalents thereto.

1. A process for providing authenticity insurance in connection with the sale of collectibles through an online marketplace, the process comprising the steps of: receiving information relating to a collectible from a dealer of collectibles, wherein the information includes collectible information and dealer data identifying the dealer; comparing the dealer data with a list of qualified dealers; and responsive to the dealer data identifying a dealer on the list of qualified dealers, offering the collectible as being available for purchase by users accessing the online marketplace, wherein the offering includes a display of the collectible, indicia indicating that the collectible is authenticated and indicia indicating that the authentication of the collectible is supported by an insurance policy assigned to the collectible and underwritten by an established insurance provider.

2. The process according to claim 1, further comprising the step of storing information relating to the authentication of the collectible offered for purchase in a collectible registry.

3. The process according to claim 2, further comprising the steps of receiving data relating to a claim that a collectible is inauthentic, wherein the claim data includes information relating to the collectible; searching the collectible registry; comparing the information received with the claim and the information stored in the collectible registry; communicating the claim data to the established insurance provider responsive to the collectible information being received in the claim data matching the collectible information stored in the collectible registry.

4. The process according to claim 3, further comprising the step of communicating a rejection of the claim that a collectible is inauthentic responsive to the information being received failing to match the collectible information stored in the collectible registry.

6. The process according to claim 1, further comprising the step of facilitating the purchase of the collectible through an escrow process.

7. The process according to claim 1, further comprising the steps of:
a) receiving dealer data relating to a plurality of collectible dealers, wherein the dealer data for each collectible dealer includes information qualifying the dealer as a collectible expert for one or more categories of collectibles selected from a plurality of preset categories of collectibles and an association between the dealer and one or more geographical areas from a plurality of geographical areas;
b) receiving collectible inventory data from a qualified dealer of the plurality of qualified collectible dealers relating to at least one collectible available for a transaction through the online website; and
c) responsive to receipt of the collectible inventory data for the at least one collectible, offering the at least one collectible for involvement in a transaction through the online website for a preset period of exclusivity and communicating the assignment of an authenticity insurance policy covering the at least one collectible, wherein the insurance policy insures the at least one collectible as being authentic.

8. The process according to claim 7, wherein the step of receiving dealer data includes comparing the information qualifying the dealer as a collectible expert with qualifying criteria.

9. The process according to claim 7, wherein the step of receiving collectible inventory data from a qualified dealer of the plurality of qualified collectible dealers relating to at least one collectible available for a transaction through the online marketplace further comprises the step of receiving a selection of one of an auction of the collectible and a sale at a fixed price.

10. A process for providing owner's title insurance in connection with the sale of collectibles through an online marketplace, the process comprising the steps of: receiving information relating to a collectible from a dealer of collectibles, wherein the information includes collectible ownership information and dealer data identifying the dealer; comparing the dealer data with a list of qualified dealers; responsive to the dealer data identifying a dealer on the list of qualified dealers, offering the collectible as being available for purchase by users accessing the online marketplace, wherein the offering includes a display of the collectible, indicia indicating that the chain of ownership of the collectible is authenticated and indicia indicating that the of the collectible is supported by a title insurance policy assigned to the collectible and underwritten by an established insurance provider; and facilitating the purchase of the collectible to a buyer through the online marketplace.

11. The process according to claim 10, further comprising the step of storing information relating to the collectible offered and the buyer in a collectible registry.

12. The process according to claim 11, further comprising the steps of receiving data relating to a claim that the collectible ownership information associated with a collectible is inauthentic, wherein the claim data includes information relating to the collectible; searching the collectible registry; comparing the information received with the claim and the information stored in the collectible registry; communicating the claim data to the established insurance provider responsive to the collectible information being received in the claim data matching the collectible information stored in the collectible registry.

13. The process according to claim 12, further comprising the step of communicating a rejection of the claim that collectible ownership information is inauthentic responsive to the information being received failing to match the collectible information stored in the collectible registry.

14. The process according to claim 10, wherein the step of facilitating the purchase of the collectible further comprising providing for the purchase and transfer of the collectible through an escrow process.

15. The process according to claim 10, further comprising the steps of:
a) receiving dealer data relating to a plurality of collectible dealers, wherein the dealer data for each collectible dealer includes information qualifying the dealer as a collectible expert for one or more categories of collectibles selected from a plurality of preset categories of collectibles and an association between the dealer and one or more geographical areas from a plurality of geographical areas;
b) receiving collectible inventory data from a qualified dealer of the plurality of qualified collectible dealers relating to at least one collectible available for a transaction through the online website; and
c) responsive to receipt of the collectible inventory data for the at least one collectible, offering the at least one collectible for involvement in a transaction through the online website for a preset period of exclusivity and communicating the assignment of an authenticity insurance policy covering the at least one collectible, wherein the insurance policy insures the at least one collectible as being authentic.

16. The process according to claim 15, wherein the step of receiving dealer data includes comparing the information qualifying the dealer as a collectible expert with qualifying criteria.

17. The process according to claim 15, wherein the step of receiving collectible inventory data from a qualified dealer of the plurality of qualified collectible dealers relating to at least one collectible available for a transaction through the online marketplace further comprises the step of receiving a selection of one of an auction of the collectible and a sale at a fixed price.

18. The process according to claim 10, wherein communication between users and the dealer is facilitated and monitored through the online marketplace.

19. A method for providing a collectible registry in connection with an online marketplace, comprising the steps of: receiving information through the online marketplace relating to a collectible, wherein the information includes collectible ownership data identifying a current owner of the collectible, authentication data identifying a dealer having verified the authenticity of the collectible and insurance policy data identifying the insurance policy and insurance provider insuring the authenticity of the collectible; storing the information in a database; updating information relating to the ownership of the collectible upon a transaction through an online marketplace.

20. A method according to claim 19, further comprising receiving information relating to a claim that a collectible is inauthentic and storing the claim information in the database in connection with the collectible information.

21. A system for facilitating transactions involving collectibles through an online marketplace, the system comprising:
a) one or more communication devices configured for receiving information relating to a collectible from a dealer of collectibles, wherein the information includes collectible information and dealer data identifying the dealer; actuating the display of information relating to the collectible on one or more remote display devices;
b) one or more processing devices configured for comparing the dealer data with a list of qualified dealers; responsive to the dealer data identifying a dealer on the list of qualified dealers, offering the collectible as being available for purchase by users accessing the online marketplace, wherein the offering includes the display of the collectible, indicia indicating that the collectible is authenticated and indicia indicating that the authentication of the collectible is supported by an insurance policy assigned to the collectible and underwritten by an established insurance provider on the one or more remote display devices; and
c) one or more data storage devices configured for storing the collectible information in a collectible registry, wherein the stored information includes ownership information, dealer data, the insurance policy assigned to the collectible and the insurance provider.

22. The system as recited in claim 21, wherein the communication devices are connected with the Internet.

23. The system as recited in claim 21, wherein the communication devices are configured for displaying one or more graphical user interfaces on the one or more remote display devices.

24. The system as recited in claim 21, wherein the one or more processing devices are further configured to update the collectible information stored in the one or more data storage devices upon the execution of a transaction involving the collectible offered for purchase through the online marketplace.

25. The system as recited in claim 24, wherein the transaction involving the collectible offered for purchase through the online marketplace is facilitated by an escrow process displayed on the one or more remote display devices.

26. The system as recited in claim 21, wherein the one or more communication devices are further configured for receiving a claim that a collectible is inauthentic.

27. The system as recited in claim 26, wherein the one or more processing devices are further configured for comparing the collectible claimed as inauthentic with the collectible information stored in the one or more data storage devices.

28. The system as recited in claim 27, wherein the one or more communication devices are configured to send a notification of the claim to the insurance provider responsive to the identification of the collectible claimed as inauthentic with the collectible information stored in the one or more data storage devices.

29. The system as recited in claim 21, wherein the one or more communication devices are further configured to display recommendations of the collectible offered for purchase to a user through the one or more remote display devices.

30. The system as recited in claim 29, wherein the display of recommendations to the user is at least partially based on the one or more processors conducting an analysis of the user's interaction with the online marketplace.
